(19) United States
(12) Patent Application Publication
(10) Pub. No.: US 2021/0150037 A1
(43) Pub. Date: May 20, 2021

(54) Secure Federation of Distributed Stochastic Gradient Descent

(71) Applicant: International Business Machines Corporation, Armonk, NY (US)

(72) Inventors: Jayaram Kallapalayam Radhakrishnan, Pleasantville, NY (US); Gegi Thomas, Danbury, CT (US); Ashish Verma, Nanuet, NY (US)

(73) Assignee: International Business Machines Corporation, Armonk, NY (US)

(21) Appl. No.: 16/684,806

(22) Filed: Nov. 15, 2019

(51) Int. Cl. G06F 21/60; H04L 9/00; G06N 20/00

(52) U.S. Cl. CPC G06F 21/602; G06N 20/00; H04L 9/008

(57) ABSTRACT

Embodiments relate to training a machine learning model based on an iterative algorithm in a distributed, federated, private, and secure manner. Participating entities are registered in a collaborative relationship. The registered participating entities are arranged in a topology and a topological communication direction is established. Each registered participating entity receives a public additive homomorphic encryption (AHE) key and local machine learning model weights are encrypted with the received public key. The encrypted local machine learning model weights are selectively aggregated and distributed to one or more participating entities in the topology responsive to the topological communication direction. The aggregated sum of the encrypted local machine learning model weights is subjected to decryption with a corresponding private AHE key. The decrypted aggregated sum of the encrypted local machine learning model weights is shared with the registered participating entities.

### BACKGROUND

The present embodiments relate to training a machine learning model based on gradient descent, including deep neural networks. More specifically, the embodiments relate to collaboration to train a machine learning model based on an iterative algorithm in a distributed, federated, private, and secure manner.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a data set to solve problems and provide relevant recommendations. For example, in the field of artificially intelligent computer systems, natural language systems (such as the IBM Watson® artificially intelligent computer system or other natural language interrogatory answering systems) process natural language based on system acquired knowledge. To process natural language, the system may be trained with data derived from a database or corpus of knowledge, but the resulting outcome can be incorrect or inaccurate for a variety of reasons.

Machine learning (ML), which is a subset of Artificial intelligence (AI), utilizes algorithms to learn from data and create foresights based on this data. ML is the application of AI through creation of models, including neural networks that can demonstrate learning behavior by performing tasks that are not explicitly programmed. Deep learning is a type of ML in which systems can accomplish complex tasks by using multiple layers of choices based on output of a previous layer, creating increasingly smarter and more abstract conclusions. Deep learning employs neural networks, referred to herein as artificial neural networks, model complex relationships between input and output and to identify patterns therein.

At the core of AI and associated reasoning lies the concept of similarity. The process of understanding natural language and objects requires reasoning from a relational perspective that can be challenging. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly.

### SUMMARY

The embodiments include a system, computer program product, and method for secured federated machine learning.

In one aspect, a system is provided for use with an artificial intelligence (AI) platform to train a machine learning model. The processing unit is operatively coupled to the memory and is in communication with the AI platform, which is embedded with tools in the form of a registration manager, an encryption manager, and an entity manager. The registration manager functions to register participating entities in a collaborative relationship, arrange the registered entities in a topology, and establish a topological communication direction. The encryption manager functions to generate and distribute a public additive homomorphic encryption (AHE) key to each registered entity. The entity manager functions to locally direct encryption of entity local machine learning model weights with a corresponding distributed AHE key. The entity manager further functions to selectively aggregate the encrypted local machine learning weights and distribute the aggregated weights to one or more entities in the topology responsive to the topological communication direction. The encryption manager subjects an aggregated sum of the encrypted local machine learning model weights to decryption with a corresponding private AHE key and distributes the aggregated sum to each entity in the topology. The encryption manager further functions to share the decrypted aggregated sum of the encrypted local machine learning model weights with the registered participating entities.

In another aspect, a computer program product is provided to train a machine learning model. The computer program product includes a computer readable storage medium having program code embodied therewith, with the program code executable by a processor to register participating entities in a collaborative relationship, arrange the registered entities in a topology, and establish a topological communication direction. Program code is provided to generate and distribute a public additive homomorphic encryption (AHE) key to each registered entity. Program code locally directs encryption of entity local machine learning model weights with a corresponding distributed AHE key. The local machine learning model weights are selectively aggregated and the aggregated weights are distributed to one or more entities in the topology responsive to the topological communication direction. Program code is further provided to subject an aggregated sum of the encrypted local machine learning model weights to decryption with a corresponding private AHE key. The decrypted aggregated sum is distributed to each entity in the topology, wherein the decrypted aggregated sum of the encrypted local machine learning model weights is shared with the registered participating entities.

In yet another aspect, a method is provided for training a machine learning model. Participating entities are registered in a collaborative relationship. The registered participating entities are arranged in a topology and a topological communication direction is established. Each registered participating entity receives a public additive homomorphic encryption (AHE) key and local machine learning model weights are encrypted with the received key. The encrypted local machine learning model weights are selectively aggregated and the selectively aggregated encrypted weights are distributed to one or more participating entities in the topology responsive to the topological communication direction. The aggregated sum of the encrypted local machine learning model weights is subjected to decryption with a corresponding private AHE key. The decrypted aggregated sum of the encrypted local machine learning model weights is shared with the registered participating entities.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a flow chart illustrating a system connected in a network environment that supports secure federation of distributed stochastic gradient descent.

FIG. 2 depicts a block diagram illustrating an artificial intelligence platform and tools, as shown and described in FIG. 1, and their associated application program interfaces.

FIG. 3 depicts a block diagram illustrating an administrative domain and intra-domain aggregation.

FIG. 4 depicts a flow chart illustrating a process for conducting an intra-domain aggregation for an administrative domain.

FIG. 5 depicts a flow chart illustrating a process for inter-domain collaboration and training of ML programs.

FIG. 6 depicts a block diagram to illustrate an example ring topology to support the process shown and described in FIG. 5.

FIG. 7 depicts a flow chart illustrating a process for arranging the entities in a fully connected topology and employing a broadcast communication protocol across the topology.

FIG. 8 depicts a flow chart illustrating a process for supporting and enabling weight encryption and aggregation over a channel or broadcast group whose membership changes dynamically.

FIG. 9 depicts a flow chart illustrating a process for encrypting local weight arrays and synchronously aggregating chunks of the arrays in parallel.

FIG. 10 depicts a block diagram illustrating an example of a computer system/server of a cloud based support system, to implement the system and processes described above with respect to FIGS. 1-9.

FIG. 11 depicts a block diagram illustrating a cloud computer environment.

FIG. 12 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Deep learning is a method of machine learning that incorporates neural networks in successive layers to learn from data in an iterative manner. Neural networks are models of the way the human brain processes information. Basic units of the neural networks are referred to as neurons, which are typically organized into layers. The neural network works by simulating a large number of interconnected processing units that resemble abstract versions of neurons. There are typically three parts in a neural network, including an input layer, with units representing input fields, one or more hidden layers, and an output layer, with a unit or units representing target field(s). The units are connected with varying connection strengths or weights. Input data are presented to the first layer, and values are propagated from each neuron to every neuron in the next layer. Eventually, a result is delivered from the output layers. Deep learning complex neural networks are designed to emulate how the human brain works, so computers can be trained to support poorly defined abstractions and problems. Neural networks and deep learning are often used in image recognition, speech, and computer vision applications.

Neural networks are comprised of interconnected layers and corresponding algorithms and adjustable weights. An optimization function that adjusts the weights is referred to as gradient descent. More specifically, gradient descent is an optimization algorithm used to minimize a function by iteratively moving in a direction of steepest descent as defined by a negative gradient. In ML, gradient descent is used to update parameters of the neural network and a corresponding neural model. This is straightforward when training on a single physical machine, or among computers within a single entity. However, when multiple entities are involved, it can either be impossible to share data due to communication limitations or due to legal reasons (regulations like HIPAA etc.). One solution is to then share weights and insights from each participating entity. It is understood in the art that sharing insights from data may lead to building a desirable or improved neural model. However, sharing data leads to other issues, such as confidentiality and privacy breaches due to other participating entities reverse engineering, e.g. reconstructing, data from the shared insights. Accordingly, as shown and described herein, a system, computer program product, and method are provided to merge encrypted weights by sharing encrypted model parameters without sharing data or weights in plain text, e.g. clear text.

As shown and described herein, an encryption key and corresponding encryption platform is utilized to encrypt the weights that are subject to sharing, and an algorithm or process is utilized to support and enable aggregation of the encrypted weights. The encryption platform leverages Additive Homomorphic Encryption (AHE), e.g. Paillier encryption, which is a type of keypair-based cryptography that utilizes a public key and a corresponding private key. Every entity uses the same public key to support and enable homomorphism for each training job. AHE provides additive homomorphism that enables messages or corresponding data to be added together while they are in encrypted form, and further support proper decryption of the additive encrypted form with the corresponding private key. As shown and described herein, AHE is applied to ML to encrypt weights of a corresponding neural network, and to share the encrypted weights with registered participating entities of a collaborative environment without encrypting or sharing corresponding data.

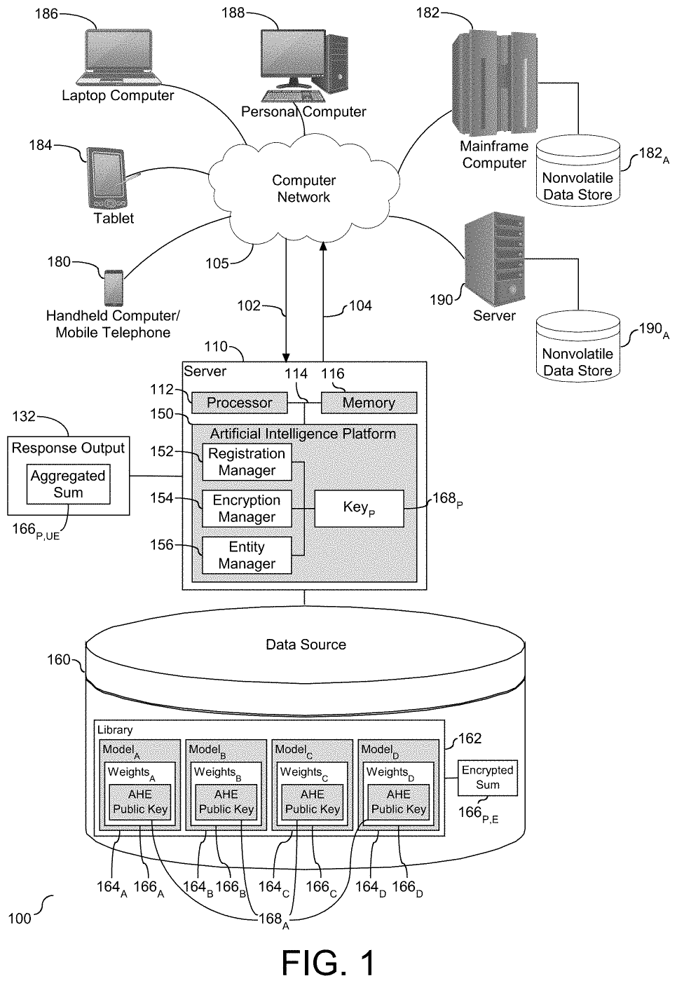

Referring to FIG. 1, a schematic diagram (100) is provided to illustrate secure federation of distributed stochastic gradient descent. As shown, a server (110) is provided in communication with a plurality of computing devices (180), (182), (184), (186), (188), and (190) across a network connection (105). The server (110) is configured with a processing unit (112) in communication with memory (116) across a bus (114). The server (110) is shown with an artificial intelligence (AI) platform (150) to support collaboration to train a machine learning model based on an iterative optimization algorithm in a distributed, federated, private and secure environment. The server (110) is in communication with one or more of the computing devices (180), (182), (184), (186), (188), and (190) over the network (105). More specifically, the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The AI platform (150) is shown herein configured to receive input (102) from various sources. For example, AI platform (150) may receive input from the network (105) and leverage a data source (160), also referred to herein as a corpus or knowledge base, to create output or response content. As shown, the data source (160) is configured with a library (162), or in one embodiment with a plurality of libraries, with the library (162) including one or more deep neural networks, referred to herein as neural models, including model_{A} (164_{A}), model_{B} (164_{B}), model_{C} (164_{C}), and model_{D}) (164_{D}). In one embodiment, the library (162) may include a reduced quantity of models or an enlarged quantity of models. Similarly, in one embodiment, the libraries in the data source (160) may be organized by common subjects or themes, although this is not a requirement. Models populated into the library may be from similar or dissimilar sources.

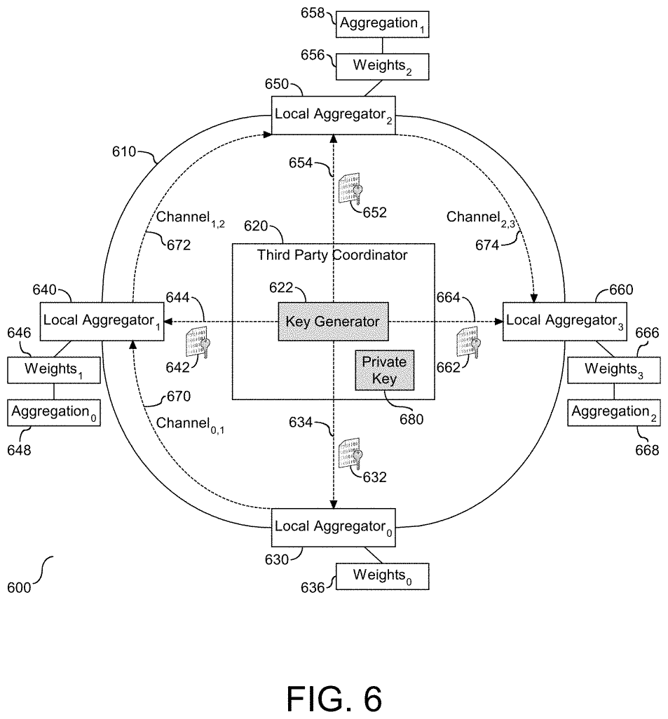

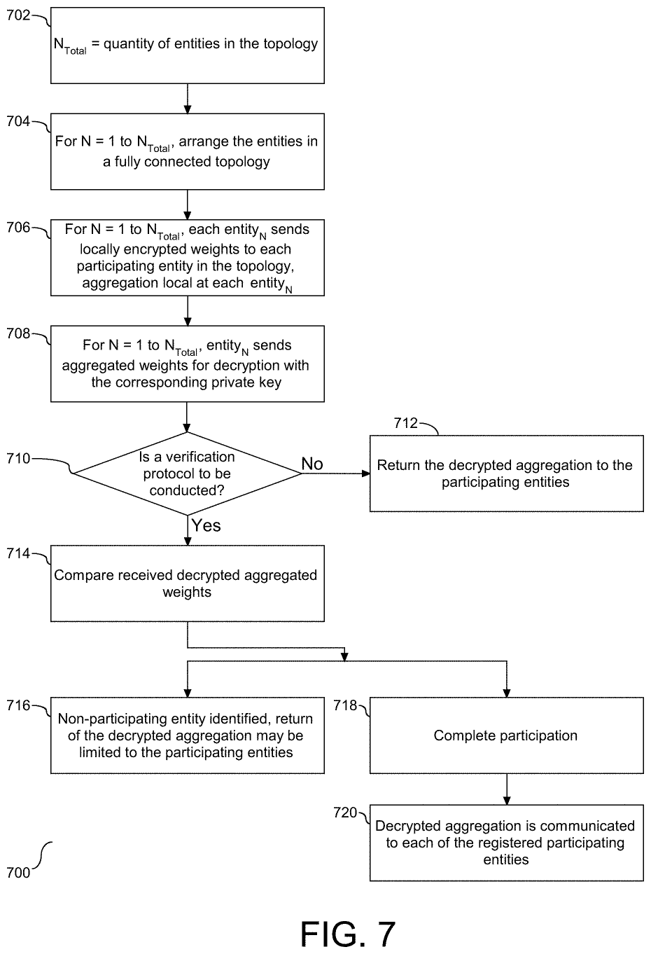

The AI platform (150) is provided with tools to support and enable machine learning collaboration. The various computing devices (180), (182), (184), (186), (188), and (190) in communication with the network (105) may include access points for the models of the data source (160). The AI platform (150) functions as a platform to enable and support collaboration without sharing insights or data. As shown and described herein, the collaboration employs a public key infrastructure (PKI) that isolates AHE key generation from weight encryption and aggregation. More specifically, as described in detail herein, additive homomorphic encryption is leveraged to enable identified or selected entities to shared neural model weights in encrypted form without sharing the data. Response output (132) in the form of a neural model with desired accuracy is obtained and shared with the entities that encompass and participate in the collaboration. In one embodiment, the AI platform (150) communicates the response output (132) to members of a collaborative topology, such as that shown and described in FIGS. 6 and 7, operatively coupled to the server (110) or one or more of the computing devices (180)-(190) across the network (105).

The network (105) may include local network connections and remote connections in various embodiments, such that the AI platform (150) may operate in environments of any size, including local and global, e.g. the Internet. The AI platform (150) serves as a back-end system to support the collaboration. In this manner, some processes populate the AI platform (150), with the AI platform (150) also including input interfaces to receive requests and respond accordingly.

The AI platform (150) is shown herein with several tools to support neural model collaboration, including a registration manager (152), an encryption manager (154), and an entity manager (156). The registration manager (152) functions to register participating entities into a collaborative relationship, including arrangement of the registered entities in a topology, and establishing a communication direction and communication protocol among the entities in the topology. For example, in one embodiment, and as shown and described below, the registered entities are arranged in a ring topology. However, the communication protocols may vary. Examples of the protocol include, but are not limited to, a linear direction protocol, a broadcast protocol, and an All-Reduce protocol. As further shown and described herein, an additive homomorphic PKI encryption platform is employed for sharing and collaboration of the neural model weights. The encryption manager (154), shown herein operatively coupled to the registration manager (152), functions to generate and distribute a public additive homomorphic encryption (AHE) key for each training job to the registered entities. The distribution is typically done per machine learning training job, although it can also be done per iteration. A corresponding private AHE key is generated, but not distributed. The public key is retained by a corresponding recipient entity. The private AHE key, hereinafter referred to as the private key, associated with each of the distributed public AHE keys is not shared with any of the recipient entities, e.g. participating entities. Accordingly, the registration manager (152) and the encryption manager (154) function to register entities participating in the collaboration, establish communication protocols, and generate and selectively distribute AHE public encryption keys.

As shown, the entity manager (156) is operatively coupled to the registration and encryption managers, (152) and (154), respectively. The entity manager (156) functions to locally direct encryption of entity local machine learning model weights with a corresponding distributed AHE key followed by an aggregation. For example, in one embodiment, each of the models, shown herein as model_{A} (164_{A}), model_{B} (164_{B}), model_{C} (164_{C}), and model_{D}) (164_{D}), is associated with a respective set of entities. In one embodiment, an entity may be any of the computing machines (180)-(190) operatively coupled to the server (110). Each model has one or more corresponding weights that are the subject of the collaboration. For example, in one embodiment, model_{A} (164_{A}) has corresponding weights (166_{A}), model_{B} (164_{B}) has corresponding weights (166_{B}), model_{C} (164_{C}) has corresponding weights (166_{C}), and model_{D} (164_{D}) has corresponding weights (166_{D}). The entity manager (156) selectively aggregates the encrypted local machine learning model weights with a corresponding public key. Different aggregation and collaboration protocols may be employed, including, but not limited to, linear transmission, broadcast, and All-Reduce. Regardless of the collaboration protocol, each entity model weights are encrypted at some point in the collaboration and aggregation process with a corresponding public AHE key. As shown herein, weights (166_{A}) are encrypted with a corresponding AHE public key (168_{A}), weights (166_{B}) are encrypted with corresponding AHE public key (168_{A}), weights (166_{C}) are encrypted with corresponding AHE public key (168_{A}), and weights (166_{D}) are encrypted with corresponding AHE public key (168_{A}). Accordingly, each of the weights is separately encrypted with the same corresponding AHE public key (168_{A}).

It is understood in the art that AHE supports additive properties. This enables the weights of the corresponding models to be aggregated while in encrypted form. Depending on the communication and collaborative protocol, the encrypted weights are subject to aggregation at different stages. For example, in a linear ring topology, the registration manager (152) assigns a rank to each participating entity in the topology. Each of the model weights are incrementally encrypted and aggregated based on their corresponding rank and the established communication direction. The entity manager (156) encrypts the weights with a locally provided AHE public key, e.g. public key (168_{A}), and communicates the encrypted weights to an adjacently positioned entity for aggregation. More specifically, the entity manager (156) aggregates the AHE encrypted weights along the topology without facilitating or enabling decryption. The registration manager (152) establishes, and in one embodiment modifies, the communication direction. For example, in a ring topology, the registration manager may establish a clockwise or counter-clockwise communication direction, and may change the direction. For example, in one embodiment, the registration manager (152) may change the direction based on available bandwidth. In a broadcast protocol, the registration manager (152) establishes the local encryption of the weights and communication of the encrypted weights from each entity to the others and the AI platform. Accordingly, the entity manager (156) supports and enables aggregation and distribution of the encrypted weights based on or responsive to the topological direction and the communication protocol(s).

The public AHE key has a corresponding private key, which is not shared with the participating entities. In one embodiment, the private key, e.g. key_{P} (168_{P}), is retained local to the encryption manager (154) of the AI platform (150). It is understood that the aggregated and encrypted weights are subject to decryption based on the communication protocols. At such time as decryption is appropriate, the encryption manager (154) subjects an aggregated and encrypted sum of the encrypted weights (166_{P,E}) to decryption with the private key, e.g. key_{P} (168_{P}), thereby creating an aggregated sum of decrypted weights (166_{P,UE}). The encryption manager (154) distributes or otherwise shares the aggregated and decrypted sum (166_{P,UE}) of the local weights to each of the participating and contributing entities. Accordingly, each entity that contributed to the aggregation receives the aggregated and decrypted sum.

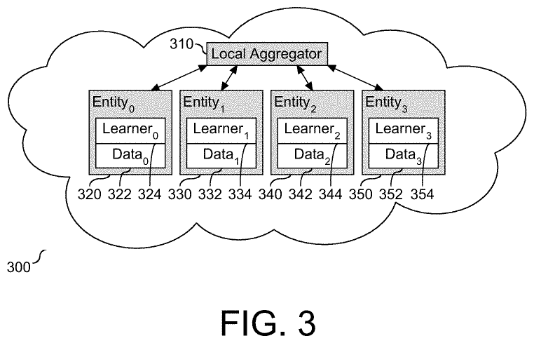

It is understood that a participating entity may be comprised of a single sub-entity, or in one embodiment, a plurality of internal sub-entities. In one embodiment, each entity has a single set of security and configuration policies for a network domain. See FIG. 3 for a demonstration of an example entity comprised of a plurality of internal sub-entities. The entity manager (156) is configured to support and enable collaborative aggregation of weights based on a single sub-entity or a plurality of sub-entities. More specifically, the entity manager (156) conducts an intra-entity aggregation of weights representing a homogeneous data type from each internal sub-entity and subjects the intra-entity aggregation to encryption with the entity AHE public key. Accordingly, the intra-entity aggregation takes place before subjecting the aggregation to AHE encryption.

The entity manager (156) subjects the intra-entity aggregation to encryption with a local public AHE encryption key. Thereafter, the encrypted aggregation is subject to inter-entity distribution across the topology. As described above, the inter-entity distribution includes aggregation of encrypted weights. Following the inter-entity aggregation of the weights and decryption with the corresponding private key, the entity manager (156) propagates the aggregated sum to each of the internal sub-entities. Accordingly, each participating entity and its associated internal sub-entity benefits from and participates in the collaboration.

The registration manager (152) is responsible for establishing the topology and communication protocols. In one embodiment, the registration manager (152) establishes a fully connected topology, also known as a mesh topology, and a corresponding broadcast protocol where each participating entity sends, e.g. broadcasts, their encrypted local weights across the topology and directly to every other participating entity in the topology. The entity manager (156) further supports and enables selective aggregation, which in this embodiment encompasses each participating entity to locally aggregate all the received broadcasted encrypted weights. The encryption manager (154) subjects each local aggregation to participation verification. The goal in the aggregation is for each participating entity to receive and benefit from the encrypted weights of the other participating entities. However, it is challenging to identify if one or more of the entities in the topology has not or is not contributing to the weight aggregation. In the mesh topology, each participating member entity can communicate directly with the encryption manager (154), and as such, the encryption manager (154) is configured to assess if it is in receipt of different aggregated weight values from different members of the topology. For example, if there are four participating entities, and three of the entities have the same aggregated weight values and one of the entities has a different aggregated weight value, then the encryption manager (154) can identify the non-contributing entity. In one embodiment, the encryption manager (154) may limit sharing of the decrypted aggregated weight sum with contributing entities, or request the identified non-contributing entity to broadcast their encrypted local weights to each of the participating members of the topology. Accordingly, as shown and described herein, the mesh topology employs a broadcast protocol, and in one embodiment entity participation verification to support the federated machine learning.

As shown and described in FIG. 1, the registration manager (152) may implement an All-Reduce algorithm or protocol for collaboration. In this embodiment, the entity manager (156) represents the weights of each entity as an array of weights. The entity manager (156) encrypts the array with the corresponding entity AHE public key, divides the encrypted array into two or more chunks, and synchronously aggregates the chunks in parallel and responsive to the topology. The entity manager (156) concludes the synchronous aggregation when each participating entity in the collaboration is in receipt of a single aggregated chunk. Each aggregated chunk is subject to decryption by the encryption manager (154) with the corresponding private key, which is followed by concatenation of the decrypted chunks, and distribution of the concatenated decrypted chunks to the registered participating entities. Accordingly, the All-Reduce protocol is an algorithm employed herein efficiently in a parallel and collective manner.

In some illustrative embodiments, server (110) may be the IBM Watson® system available from International Business Machines Corporation of Armonk, New York, which is augmented with the mechanisms of the illustrative embodiments described hereafter. The IBM Watson® system shown and described herein includes tools to implement federated machine learning based on iterative optimization algorithms. The tools enables selective aggregation of encrypted model weights without sharing the underlying data, thereby enabling the data to remain confidential or private.

The registration manager (152), encryption manager (154), and entity manager (156), hereinafter referred to collectively as AI tools or AI platform tools, are shown as being embodied in or integrated within the AI platform (150) of the server (110). The AI tools may be implemented in a separate computing system (e.g., 190) that is connected across network (105) to the server (110). Wherever embodied, the AI tools function to support and enable federated machine learning in an iterative manner, including encryption of local model weights and sharing of the encrypted local model weights among participating entities, without sharing or disclosing underlying data. Output content (132) may be in the form of a decrypted format of the aggregated weights that is subject to inter-entity communication.

Types of information handling systems that can utilize the AI platform (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various information handling systems can be networked together using computer network (105). Types of computer networks (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (190) utilizes non-volatile data store (190_{A}), and mainframe computer (182) utilizes nonvolatile data store (182_{A}). The nonvolatile data store (182_{A}) can be a component that is external to the various information handling systems or can be internal to one of the information handling systems.

The information handling system employed to support the AI platform (150) may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory. In addition, an information handling system need not necessarily embody the north bridge/south bridge controller architecture, as it will be appreciated that other architectures may also be employed.

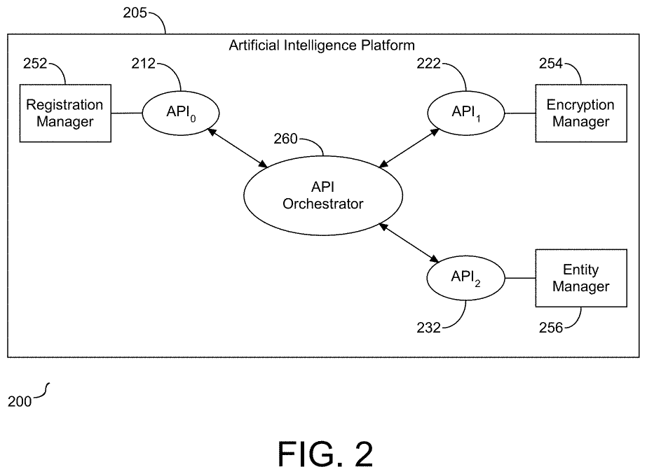

An Application Program Interface (API) is understood in the art as a software intermediary between two or more applications. With respect to the AI platform (150) shown and described in FIG. 1, one or more APIs may be utilized to support one or more of the tools (152)-(156) and their associated functionality. Referring to FIG. 2, a block diagram (200) is provided illustrating the tools (152)-(156) and their associated APIs. As shown, a plurality of tools are embedded within the AI platform (205), with the tools including the registration manager (252) associated with API₀ (212), the encryption manager (254) associated with API₁ (222), and the entity manager (256) associated with API₂ (232). Each of the APIs may be implemented in one or more languages and interface specifications. API₂ (212) provides functional support to register participating entities, arrange the topology, and establish communication protocols; API₁ (222) provides functional support to generate and distribute public AHE keys for each of the registered entities, manage decryption of aggregated weights with a corresponding private key, and manage distribution of the decrypted weights, and API₂ (232) provides functional support to direct intra-entity aggregation and inter-entity aggregation responsive to the topology. As shown, each of the APIs (212), (222), and (232) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

Referring to FIG. 3, a block diagram (300) is provided to illustrate an administrative domain and intra-domain aggregation. A registered participating entity (310) is referred to herein as a local aggregator (LA) that is operatively coupled to one or more local computing entities. In the example shown herein, there are four local computing entities, including entity₀ (320), entity ₁ (330), entity₂ (340), and entity₃ (350). Each computing entity includes or utilizes one or more machine learning programs, referred to herein as learners, supported by operatively coupled data. As shown herein entity₀ (320) is shown with learner₀ (322) and operatively coupled data₀ (324), entity₁ (330) is shown with learner₁ (332) and operatively coupled data₁ (334), entity₂ (340) is shown with learner₂ (342) and operatively coupled data₂ (344), and entity₃ (350) is shown with learner₃ (352) and operatively coupled data₃ (354). Each machine learning program(s), e.g. learner, extracts and processes the local data into a corresponding local neural model.

Data that stems from the same classification may be applied to different neural models built or utilizing the same data classification. In the example shown herein, each of the learners (322), (332), (342), and (352) represent the same machine learning program for the same data type, e.g. homogenous data classification, but with different data. The LA (310) supports and enables the learners to share the weights with or without sharing the underlying data. The LA (310) performs an aggregation of the received weights, and in one embodiment averages the received weights, without performing an AHE encryption. Accordingly, the administrative domain shown and described herein represents an entity, which in one embodiment may be a business entity or domain, to support internal aggregation of weights, e.g. intra-entity aggregation, from processes internal to the domain.

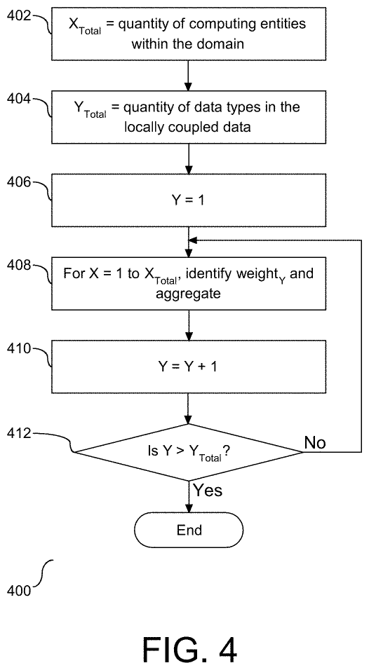

Referring to FIG. 4, a flow chart (400) is provided to illustrate a process for conducting an intra-domain aggregation for an administrative domain. The variable X_{Total} represents the quantity of computing entities within the domain (402). The domain may be comprised of a single or multiple computing entities. As shown in FIG. 3, each computing entity has a machine learning program and locally coupled data, with each machine learning program representing a homogenous class of data. The variable Y_{Total} represents the quantity of data types that may be present in the locally coupled data (404). In one embodiment, the value of the data types is aligned with the quantity of machine learning programs. The data type counting variable, Y, is initialized (406). For each computing entity, X, the weights in ML program_{Y} corresponding to data type_{Y}, e.g. weights_{Y}, are identified and aggregated (408). The process of aggregating weights may be applied to different ML programs for a different data type. As shown, following step (408), the data type counting variable, Y, is incremented (410) to account for the next ML program, and it is determined if each of the data types have been processed for weight aggregation (412). A negative response to the determination is followed by a return to step (408), and a positive response to the determination concludes the aggregation. In one embodiment, the data type may be specified and the aggregation may be limited to the specified data type. Accordingly, intra-entity aggregation of weights may be conducted across two or more computing entities residing in a designated or defined domain without conducting or employing any AHE encryption.

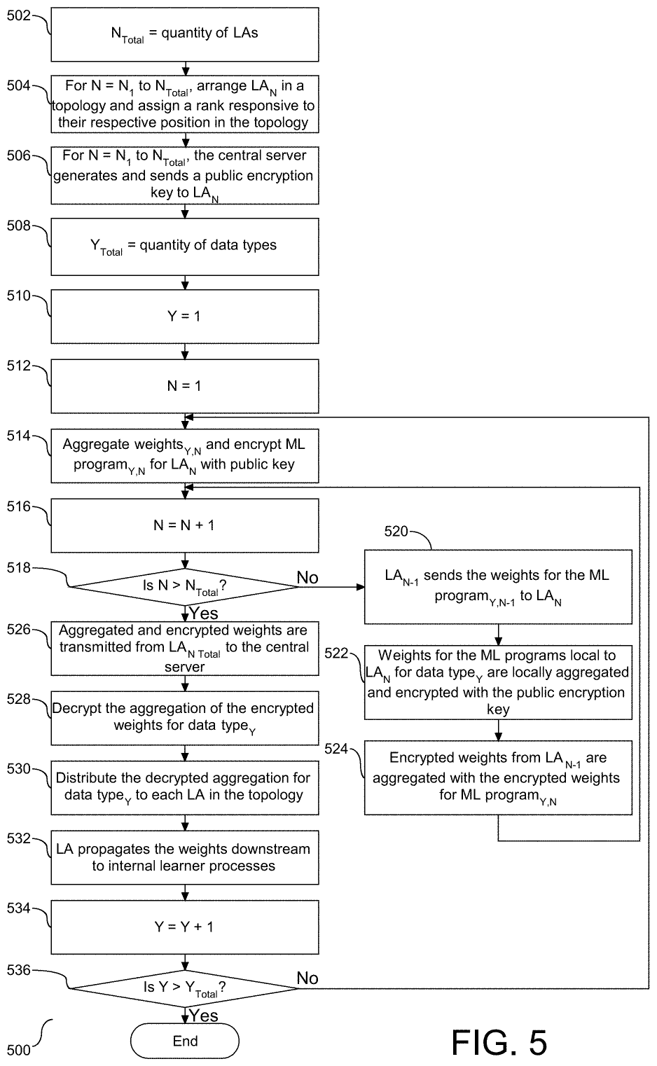

Multiple domains may be arranged in a defined topology. Each domain has a corresponding LA operatively coupled to one or more entities and associated ML programs. Weights from the ML programs may be shared on an inter-domain basis without sharing the data. More specifically, the weights are encrypted in a manner that supports aggregation while maintaining the encryption. The inter-domain sharing of the weights supports and enables collaboration and enhanced training of ML programs. Referring to FIG. 5, a flow chart (500) is provided to illustrate a process for inter-domain collaboration and training of ML programs. The variable N_{Total} is assigned to the quantity of LAs that are subject to the collaboration (502). It is understood that each LA is addressable and has a corresponding address identifier. Each of the LAs are arranged in a topology and assigned a rank responsive to their respective position in the topology (504). In addition, a communication protocol is established for inter-domain communication within the topology. For descriptive purposes, the topology employed herein is a linear ring topology where the LAs are connected in a ring and pass information to or from each other according to their adjacent proximity in the ring structure and a designated direction, e.g. clockwise or counter-clockwise. A server, such as the central server (620) shown and described in FIG. 6, and also referred to as a third party coordinator, which in one embodiment is the AI Platform (150) local to the central server (110), is provided in communication with the topology and the LAs assigned to the topology, and functions to generate and assign encryption keys. Each LA in the topology is assigned an encryption key. As shown, the AI platform (150) generates and sends the public encryption key to each LA in the topology (506). The public key has a corresponding private key that is retained by the central server. The encryption platform utilized by the central server leverages Additive Homomorphic Encryption (AHE), e.g. Paillier encryption. Accordingly, the topology and communication protocols are established with three or more LAs populated into the topology.

As shown and described in FIGS. 3 and 4, each ML program is representative of a specific data type. Each LA may have one or more ML programs, with each program associated or assigned a different data type. The variable Y_{Total} is assigned to represent the quantity of data types (508), and the data type counting variable and the LA counting variable are individually initialized at (510) and (512), respectively. Thereafter, the weight aggregation process is initiated. As shown, LA_{N} is identified, and the weights for the ML programs local to LA_{N} for data type_{Y} are aggregated and encrypted with the public encryption key (514). In one embodiment, LA_{N} is limited to a single ML program for data type_{Y}. Following step (514), the LA counting variable is incremented (516), followed by determining if there are any more LAs in the topology that have not been subject to weight aggregation (518). A negative response to the determination at step (518) is followed by LA_{N-1} sending the weights for the ML program_{Y,N-1} to LA_{N} (520). Following receipt of the weights, the weights for the ML programs local to LA_{N} for data type_{Y} are locally aggregated and encrypted with the public encryption key (522). The encrypted weights received from LA_{N-1} are aggregated with the encrypted weights for ML program_{Y,N} (524). Once the aggregation at LA_{N} is completed, the process returned to step (516). Accordingly, the aggregation of the weights takes place on an intra-domain and inter-domain basis.

A positive response to the determination at step (518) is an indication that each of the LAs in the topology has completed a revolution of the ring. As shown herein, the weights of each of the LAs has been completed in an encrypted form, with the weights of each contributing LA having the same public encryption key. The aggregated and encrypted weights are transmitted from LA_{N Total} to the central server (526). The only entity with the complete aggregation is LA_{NTotal}. The central server leverages the private key associated the public key distributed in the topology and decrypts the aggregation of the encrypted weights for data type_{Y} (528). The central server distributes the decrypted aggregation for data type_{Y} to each LA in the topology (530). Upon receipt of the decrypted aggregation from the central server, the respective LA propagates the weights downstream to internal learner processes (532). Thereafter, the data type counting variable is incremented (534), and it is determined if each of the data types, e.g. ML programs as shown and described in FIG. 4, have been processed with respect to weight aggregation (536). A negative response to the determination is followed by a return to step (514), and a positive response concludes the aggregation process. Accordingly, the aggregation shown and described herein is limited to the weights in the corresponding ML programs and does not extend to the associated data.

Referring to FIG. 6, a block diagram (600) is provided to illustrate an example ring topology to support the process shown and described in FIG. 5. As shown, a central server (620), also referred to herein as a third party coordinator, is configured or provided with a key generator (622) to generate the public key for distribution and a private key (680) to be locally retained. In this example, there are four LAs represented in the topology (610), including LA₀ (630), LA₁ (640), LA₂ (650), and LA₃ (660), although the quantity of LAs is for descriptive purposes and should not be considered limiting. Each individual LA may be comprised of a single learner or multiple learners, as shown in FIG. 3, forming an internal domain. The central server (620) is operatively coupled to each LA in the topological structure. More specifically, the central server (620) creates a public key for each LA (630), (640), (650), and (660), and communicates the public key across a respective communication channel. As shown herein, server (620) communicates public key (632) to LA₀ (630) across communication channel° (634). Similarly, server (620) communicates the public key (642) to LA₁ (640) across communication channel₁ (644), the public key (652) to LA₂ (650) across communication channel₂ (654), and the public key (662) to LA₃ (660) across communication channel₃ (664). The public key (632) (642), (652), and (662) is the same public key for each LA and supports AHE encryption.

As shown herein, the encryption of the weights in this example originates at LA₀ (630). The weights of the local model at LA₀ (630), for a specific data type or data classification, are computed and encrypted with key₀ (632) and communicated to LA₁ (640) across communication channel_{0,1} (670). The encrypted weights for LA₀ (630) referred to herein as weights₀ (636). Following receipt of weights₀ (636) from LA₀ (630), the weights of the local model at LA₁ (640) for the same specific data type or data classification are computed and encrypted with key₁ (642). The encrypted weights for LA₁ (640) referred to herein as weights₁ (646). The encrypted weights of local model LA₁ (640), weights₁ (646), are aggregated with the encrypted weights, weights₀ (636), of local model LA₀ (630). The aggregation is also referred to herein as a first aggregation, e.g. aggregation₀ (648). The process of encryption and aggregation continues across the ring topology in the established direction. As shown, aggregation₀ (648) is communicated to LA₂ (650) across communication channel_{1,2} (672). Following receipt of aggregation₀ (648) from LA₁ (640), the weights of the local model at LA₂ (650) for the same specific data type or data classification are computed and encrypted with key₂ (652). The encrypted weights for LA₂ (650) are referred to herein as weights₂ (656). The encrypted weights of local model LA₂ (650), weights₂ (656), are aggregated with aggregation₀ (648) received from LA₁ (640). The aggregation is also referred to herein as a second aggregation, e.g. aggregation₁ (658). As shown, aggregation₁ (658) is communicated to LA₃ (660) across communication channel_{2,3} (674). Following receipt of aggregation₁ (658) from LA₂ (650), the weights of the local model at LA₃ (660) for the same specific data type or data classification are computed and encrypted with key₃ (662). The encrypted weights for LA₃ (660) referred to herein as weights₃ (666). The encrypted weights of local model LA₃ (660), weights₃ (666), are aggregated with aggregation₁ (658) received from LA₂ (650). The aggregation is also referred to herein as a third aggregation, e.g. aggregation₂ (668). Accordingly, weights are encrypted and aggregated across the topology in a specified direction.

Following completion of the aggregation at LA₃ (660), aggregation₂ (668) is communicated to the central server (620), e.g. third party coordinator, across communication channel (664). The central server (620) does not have the underlying data associated with the aggregated weights or the individual weights that comprise the aggregation. The central server (620) is in possession of a private key (680) associated with the public key. The central server (620) decrypts the aggregation, e.g. aggregation₂ (668), with the private key (680), and sends the decrypted aggregation to each LA that is a member of the topology. As shown herein, the decrypted aggregation is communicated to LA₀ (630) across communication channel₀ (634), and is further communicated to LA₁ (640) across communication channel₁ (644), LA₂ (650) across communication channel₂ (654), and LA₃ (660) across communication channel₃ (664). Accordingly, the homomorphic encryption platform shown and described herein with respect to the ring topology supports additive encryption of weights associated with each neural model while maintaining the privacy and confidentiality of the corresponding data.

The encryption platform shown and described in FIG. 6 is directed to a ring topology for a homogeneous data type, e.g. a single data type. In one embodiment, the aggregation and encryption supported in the platform may be utilized for a second or different data type, with the encryption and aggregation for each data type taking place serially or in parallel.

As shown and described in FIG. 1, the topology and corresponding communication protocol is not limited to a ring topology. Referring to FIG. 7, a flow chart (700) is provided to illustrate a process for arranging the entities in a fully connected topology and employing a broadcast communication protocol across the topology. The variable N_{Total} represents the quantity of entities in the topology (702). The entities are arranged in a fully connected topology, also referred to herein as a mesh topology, (704). In one embodiment, each participating entity includes or is in the form of an LA. Each participating entity has locally encrypted weights and sends their locally encrypted weights, e.g. AHE encrypted weights, directly to each participating entity in the topology (706). The aggregation of the AHE encrypted weights takes place locally. More specifically, each participating entity aggregates all the received encrypted weights. Each participating entity is operatively coupled to the decryptor, e.g. third party coordinator, and sends their aggregated weights to the decryptor for decryption with the corresponding private key (708).

Based on the topology and established communication protocol, the decryptor is configured to share the decryption with each participating entity, and in one embodiment, may verify participation. Following step (708) it is determined if a verification protocol is to be conducted (710). A negative response to the determination is followed by returning the decrypted aggregation to the participating entities so that each participating entity is in receipt of the decrypted aggregation (712). It is understood in the art that there may be bandwidth constraints. In one embodiment, a single participating entity may be designated to communicate with the decryptor for transmission of the encrypted aggregated sum. Similarly, in one embodiment, each participating entity may separately communicate with the decryptor for transmission of the encrypted aggregated sum and receipt of the decrypted aggregated sum. In one embodiment, the participating entities do not have the knowledge or details of the other participating entities, and as such, the decryptor is responsible for transmission of the decrypted aggregation of the weights.

In theory, each of the participating entities should have an identical encrypted aggregation. A positive response to the determination at step (710) is followed by performing a verification protocol. The received decrypted aggregated weights from each participating entity are compared to identify a non-participating entity (714). In one embodiment, at step (714) the quantity of received encrypted weight aggregations are compared with the quantity of requested decryptions. Similarly, in one embodiment, at step (714), the values of the received encrypted weight aggregations are compared to ascertain if there is an outlier. If a non-participating entity is identified at step (716), the return of the decrypted aggregation may be limited to the participating entities (716). Similarly, if there is no entity identified as non-participating at step (718), then the decrypted aggregation is communicated to each of the registered participating entities (720). Accordingly, the topology shown and described herein supports and enables identification of non-participating entities.

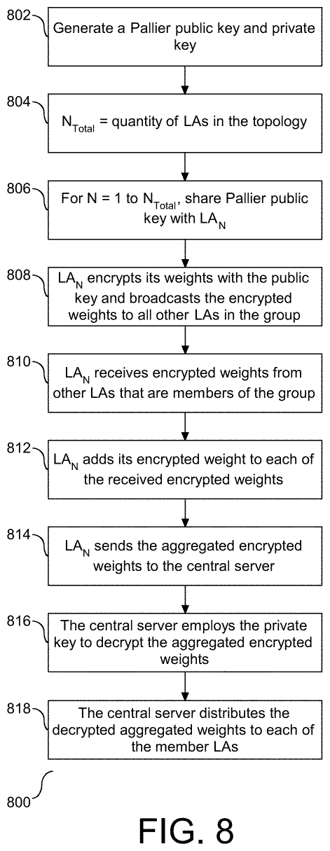

The aggregation protocol may be amended or modified to support dynamic modification of membership within the topology, e.g. membership of the local aggregators. Referring to FIG. 8, a flow chart (800) is provided to illustrate a process for supporting and enabling weight encryption and aggregation over a channel or broadcast group whose membership changes dynamically. A server or third party coordinator generates a Paillier public key and a corresponding private key, and prepares to share the public key with LAs in the topology (802). The variable N_{Total} is assigned to the quantity, or in one embodiment an initial quantity, of LAs in the topology (804). The generated Paillier public key is shared with each LA in the topology (806). In one embodiment, as an LA joins the topology, also referred to herein as a group of inter-connected LAs, the server or third party coordinator either generates the Paillier public key and corresponding private key and shares the public key with each joining or joined LA, or share a previously generated Paillier public with the LA joining the topology.

Accordingly, each LA that is a member of the topology is in communication with the central server and is in receipt of the Paillier public key for weight encryption.

The LAs in receipt of the encryption key(s) form a group. However, each LA in the formed group does not have to know about the other LAs. As shown herein, an LA in the group, referred to herein as LA_{N}, encrypts its weights with the public key and then broadcasts the encrypted weights to all other LAs in the group (808). Following the broadcast of the encrypted weights from LA_{N} at step (808), LA_{N} receives encrypted weights from all other LAs that are members of the group (810). LA_{N} adds its encrypted weight to each of the received encrypted weights (812), hereinafter referred to as aggregation encrypted weights, and sends the aggregated encrypted weights to the central server, e.g. third party coordinator, (814). The central server employs the private key to decrypt the aggregated encrypted weights (816), and distributes the decrypted aggregated weights to each of the member LAs (818). Accordingly, the process shown herein leverages the encryption keys in a broadcast scenario.

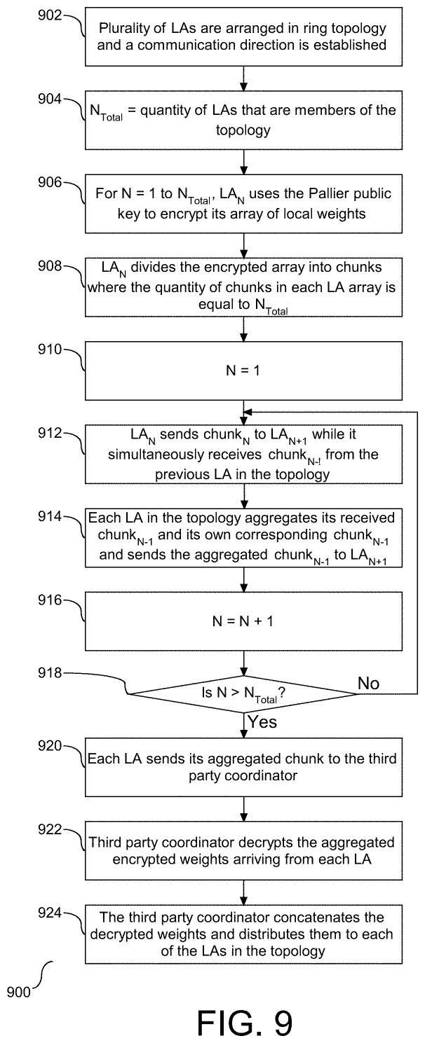

It is understood in the art of AI and ML that one or more LAs that are members of the topology shown and described in FIG. 6, e.g. ring topology, may have a large array of weights corresponding to results of local aggregation. Referring to FIG. 9, a flow chart (900) is provided to illustrate a process for encrypting local weight arrays and synchronously aggregating chunks of the arrays in parallel. A plurality of LAs is arranged in a ring topology and a communication direction is established (902), as shown and described in FIG. 6. The variable N_{Total} is assigned to the quantity of LAs that are members of the topology (904). Each LA, e.g. LA_{N}, uses the Paillier public key to encrypt its array of local weights (906). Instead of sending the array of weights in their entirety across the topology, either in a ring or a broadcast manner, each LA divides the encrypted array into sections (908), referred to herein as chunks, where the quantity of chunks in each LA array is equal to the quantity of LAs that are members of the topology, N_{Total}. A ring All-Reduce algorithm is invoked by initializing the LA and chunk counting variable, N, (910). LA_{N} sends chunk_{N} to the next LA in the ring, e.g. LA_{N+1} while it, e.g. LA_{N}, simultaneously receives chunk_{N-1} from the previous LA in the topology responsive to the communication direction (912). Each LA in the topology then aggregates its received chunk_{N-1} and its own corresponding chunk_{N-1}, and sends the aggregated chunk_{N-1} to the next LA in the ring, e.g. LA_{N+1}, (914). Thereafter, the counting variable N is incremented (916), followed by determining if N is greater than one less than N_{Total} (918). A negative response to the determination at step (918) is followed by a return to step (912), and a positive response is an indication that each LA has an aggregated chunk of the weights. The chunks are synchronously aggregated in parallel across the ring topology. Accordingly, each LA adds its local chunk to a received chunk, and sends it to the next LA responsive to the communication direction.

Following the positive response to the determination at step (918), each LA in the topology has one aggregated chunk of weights which is Paillier encrypted. In an example with four LAs, LA₁ has aggregated chunk₂, LA₂ has aggregated chunk₃, LA₃ has aggregated chunk₄, and LA₄ has aggregated chunk₁. Each LA sends its aggregated chunk to the third party coordinator (920), which functions to decrypt the aggregated encrypted weights arriving from each LA (922). The third party coordinator concatenates the decrypted weights and distributes them to each of the LAs in the topology (924). Accordingly, the process shown and described herein adapted the All-reduce algorithm to efficient and secure aggregation of weights among LAs arranged in a topology.

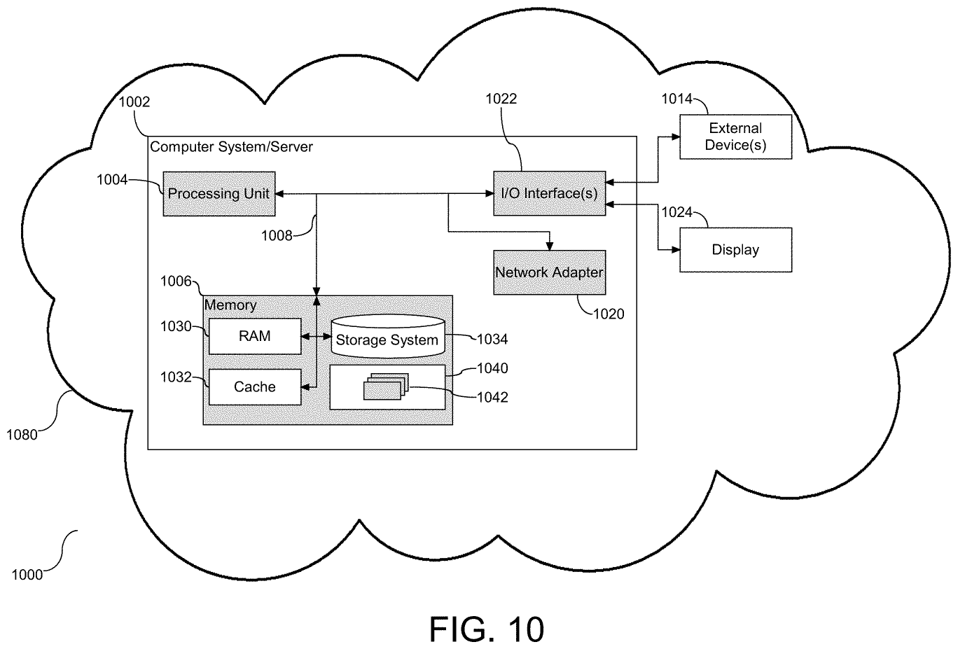

Aspects of the functional tools (152)-(156) and their associated functionality may be embodied in a computer system/server in a single location, or in one embodiment, may be configured in a cloud based system sharing computing resources. With references to FIG. 10, a block diagram (1000) is provided illustrating an example of a computer system/server (1002), hereinafter referred to as a host (1002) in communication with a cloud based support system, to implement the processes described above with respect to FIGS. 1-9. Host (1002) is operational with numerous other general purpose or special purpose computing system environments or configurations. Examples of well-known computing systems, environments, and/or configurations that may be suitable for use with host (1002) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (1002) may be described in the general context of computer system-executable instructions, such as program modules, being executed by a computer system. Generally, program modules may include routines, programs, objects, components, logic, data structures, and so on that perform particular tasks or implement particular abstract data types. Host (1002) may be practiced in distributed cloud computing environments (1080) where tasks are performed by remote processing devices that are linked through a communications network. In a distributed cloud computing environment, program modules may be located in both local and remote computer system storage media including memory storage devices.

As shown in FIG. 10, host (1002) is shown in the form of a general-purpose computing device. The components of host (1002) may include, but are not limited to, one or more processors or processing units (1004), e.g. hardware processors, a system memory (1006), and a bus (1008) that couples various system components including system memory (1006) to processor (1004). Bus (1008) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (1002) typically includes a variety of computer system readable media. Such media may be any available media that is accessible by host (1002) and it includes both volatile and non-volatile media, removable and non-removable media.

Memory (1006) can include computer system readable media in the form of volatile memory, such as random access memory (RAM) (1030) and/or cache memory (1032). By way of example only, storage system (1034) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (1008) by one or more data media interfaces.

Program/utility (1040), having a set (at least one) of program modules (1042), may be stored in memory (1006) by way of example, and not limitation, as well as an operating system, one or more application programs, other program modules, and program data. Each of the operating systems, one or more application programs, other program modules, and program data or some combination thereof, may include an implementation of a networking environment. Program modules (1042) generally carry out the functions and/or methodologies of embodiments to dynamically communication evaluation interrogatory identification and processing. For example, the set of program modules (1042) may include the tools (152)-(156) as described in FIG. 1.

Host (1002) may also communicate with one or more external devices (1014), such as a keyboard, a pointing device, etc.; a display (1024); one or more devices that enable a user to interact with host (1002); and/or any devices (e.g., network card, modem, etc.) that enable host (1002) to communicate with one or more other computing devices. Such communication can occur via Input/Output (I/O) interface(s) (1022). Still yet, host (1002) can communicate with one or more networks such as a local area network (LAN), a general wide area network (WAN), and/or a public network (e.g., the Internet) via network adapter (1020). As depicted, network adapter (1020) communicates with the other components of host (1002) via bus (1008). In one embodiment, a plurality of nodes of a distributed file system (not shown) is in communication with the host (1002) via the I/O interface (1022) or via the network adapter (1020). It should be understood that although not shown, other hardware and/or software components could be used in conjunction with host (1002). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (1006), including RAM (1030), cache (1032), and storage system (1034), such as a removable storage drive and a hard disk installed in a hard disk drive.

Computer programs (also called computer control logic) are stored in memory (1006). Computer programs may also be received via a communication interface, such as network adapter (1020). Such computer programs, when run, enable the computer system to perform the features of the present embodiments as discussed herein. In particular, the computer programs, when run, enable the processing unit (1004) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In one embodiment, host (1002) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

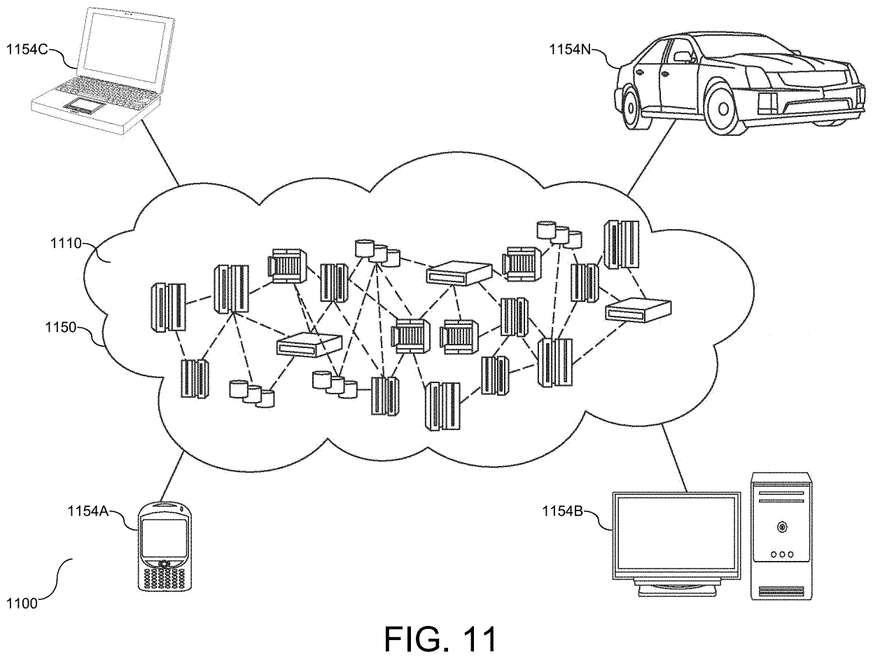

Referring now to FIG. 11, an illustrative cloud computing network (1100). As shown, cloud computing network (1100) includes a cloud computing environment (1150) having one or more cloud computing nodes (1110) with which local computing devices used by cloud consumers may communicate. Examples of these local computing devices include, but are not limited to, personal digital assistant (PDA) or cellular telephone (1154A), desktop computer (1154B), laptop computer (1154C), and/or automobile computer system (1154N). Individual nodes within nodes (1110) may further communicate with one another. They may be grouped (not shown) physically or virtually, in one or more networks, such as Private, Community, Public, or Hybrid clouds as described hereinabove, or a combination thereof. This allows cloud computing environment (1100) to offer infrastructure, platforms and/or software as services for which a cloud consumer does not need to maintain resources on a local computing device. It is understood that the types of computing devices (1154A-N) shown in FIG. 11 are intended to be illustrative only and that the cloud computing environment (1150) can communicate with any type of computerized device over any type of network and/or network addressable connection (e.g., using a web browser).

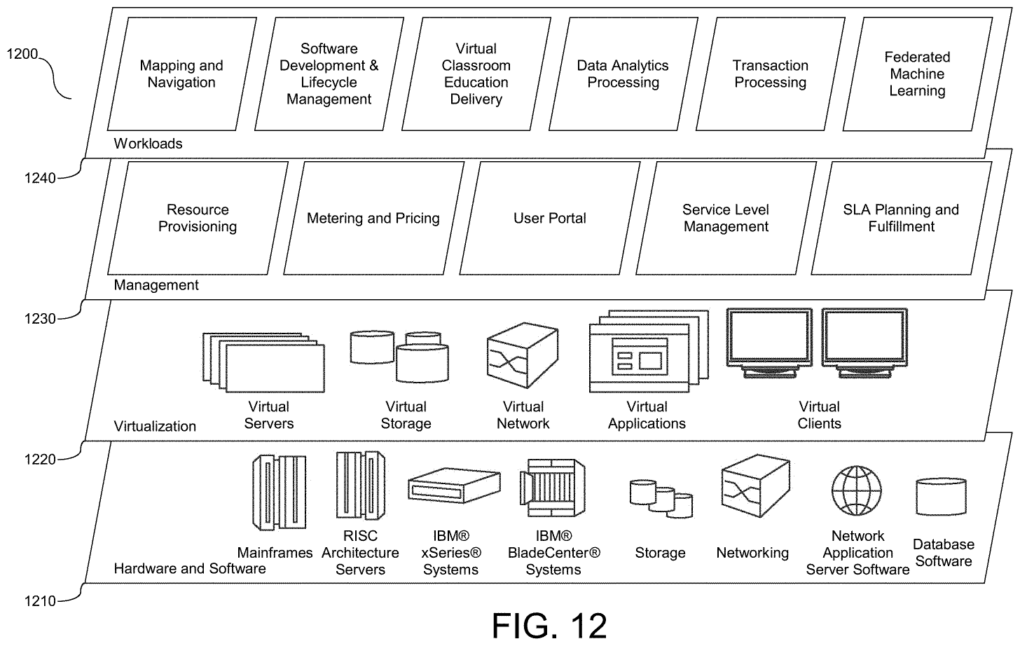

Referring now to FIG. 12, a set of functional abstraction layers (1200) provided by the cloud computing network of FIG. 11 is shown. It should be understood in advance that the components, layers, and functions shown in FIG. 12 are intended to be illustrative only, and the embodiments are not limited thereto. As depicted, the following layers and corresponding functions are provided: hardware and software layer (1210), virtualization layer (1220), management layer (1230), and workload layer (1240).

The hardware and software layer (1210) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (1220) provides an abstraction layer from which the following examples of virtual entities may be provided: virtual servers; virtual storage; virtual networks, including virtual private networks; virtual applications and operating systems; and virtual clients.

In one example, management layer (1230) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (1240) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and federated machine learning.

It will be appreciated that there is disclosed herein a system, method, apparatus, and computer program product for evaluating natural language input, detecting an interrogatory in a corresponding communication, and resolving the detected interrogatory with an answer and/or supporting content.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product is operative to improve the functionality and operation of an artificial intelligence platform to resolve interrogatories with intent identification and a corresponding response related to the identified intent.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. Accordingly, the scope of protection of the embodiments is limited only by the following claims and their equivalents.

What is claimed is:

1. A system comprising:
a processing unit operatively coupled to memory;
an artificial intelligence (AI) platform in communication with the processing unit, the AI platform to train a machine learning model, the AI platform comprising:
a registration manager to register participating entities in a collaborative relationship, arrange the registered entities in a topology, and establish a topological communication direction;
an encryption manager to generate and distribute a public additive homomorphic encryption (AHE) key to each registered entity;
an entity manager to locally direct encryption of entity local machine learning model weights with a corresponding distributed AHE key, selectively aggregate the encrypted local machine learning model weights, and distribute the selectively aggregated encrypted weights to one or more entities in the topology responsive to the topological communication direction;
the encryption manager to subject an aggregated sum of the encrypted local machine learning model weights to decryption with a corresponding private AHE key, and distribute the decrypted aggregated sum to each entity in the topology.

2. The system of claim 1, wherein a single participating entity is comprised of two or more internal entities, and further comprising the entity manager to:
aggregate weights from one or more machine learning models locally coupled to the two or more internal entities; and
locally encrypt the aggregated weights with the public AHE key, wherein the aggregated weights represent a homogenous data type.

3. The system of claim 2, further comprising the entity manager to receive the decrypted aggregated sum from the encryption manager, and propagate the aggregated sum to the two or more locally coupled machine learning models.

4. The system of claim 1, wherein the topology is a ring topology, and further comprising the registration manager to assign a rank to each participating entity in the topology, and incrementally encrypt and aggregate machine learning model weights in a first topological direction responsive the assigned rank in the topology.

5. The system of claim 4, further comprising the registration manager to modify the first topological direction responsive to available communication bandwidth.

6. The system of claim 1, further comprising the registration manager to arrange the participating entities in a fully connected topology, and further comprising:
the entity manager to engage a broadcasting protocol, wherein each participating entity broadcasts the encrypted local machine learning model weights across the topology, and wherein the selective aggregation further comprises each participating entity to locally aggregate received broadcasted encrypted weights; and
the encryption manager to subject each local aggregation to participation verification.

7. The system of claim 1, further comprising the entity manager to represent the local machine learning model weights as an array of weights, divide the encrypted array into a plurality of two or more chunks, wherein a quantity of chunks is an integer representing a quantity of the registered participants, locally encrypt each chunk with the AHE public key, and synchronously aggregate the chunks in parallel and responsive to the topology.

8. A computer program product to train a machine learning model, the computer program product comprising a computer readable storage medium having program code embodied therewith, the program code executable by a processor to:
register participating entities in a collaborative relationship, arrange the registered entities in a topology, and establish a topological communication direction;
generate and distribute a public additive homomorphic encryption (AHE) key to each registered entity;
locally direct encryption of entity local machine learning model weights with a corresponding distributed AHE key, selectively aggregate the encrypted local machine learning model weights, and distribute the selectively aggregated encrypted weights to one or more entities in the topology responsive to the topological communication direction; and
subject an aggregated sum of the encrypted local machine learning model weights to decryption with a corresponding private AHE key, and distribute the decrypted aggregated sum to each entity in the topology.

9. The computer program product of claim 8, wherein a single participating entity is comprised of two or more internal entities, and further comprising program code to:
aggregate weights from one or more machine learning models locally coupled to the two or more internal entities; and
locally encrypt the aggregated weights with the public AHE key, wherein the aggregated weights represent a homogenous data type.

10. The computer program product of claim 9, further comprising program code to receive the decrypted aggregated sum, and propagate the aggregated sum to the two or more internal entities.

11. The computer program product of claim 8, wherein the topology is a ring topology, and further comprising product code to assign a rank to each participating entity in the topology, and incrementally encrypt and aggregate machine learning model weights in a first topological direction responsive the assigned rank in the topology.

12. The computer program product of claim 11, further comprising the program code to modify the first topological direction responsive to available communication bandwidth.

13. The computer program product of claim 8, further comprising program code to represent the local machine learning model weights as an array of weights, divide the encrypted array into a plurality of two or more chunks, wherein a quantity of chunks is an integer representing a quantity of the registered participants, locally encrypt each chunk with the AHE public key, and synchronously aggregate the chunks in parallel and responsive to the topology.

14. The computer program product of claim 8, wherein the topology is fully connected, and further comprising program code to:
broadcast the encrypted local machine learning model weights across the topology;
locally aggregate received broadcasted encrypted weights; and
subject each local aggregation to verification of entity participation.

15. A method comprising:
registering participating entities in a collaborative relationship to train a machine learning model;
arranging the registered participating entities in a topology, and establishing a topological communication direction;
each registered participating entity receiving a public additive homomorphic encryption (AHE) key and encrypting local machine learning model weights with the received key;
selectively aggregating the encrypted local machine learning model weights and distributing the selectively aggregated encrypted weights to one or more participating entities in the topology responsive to the topological communication direction; and
subjecting an aggregated sum of the encrypted local machine learning model weights to decryption with a corresponding private AHE key and distributed the decrypted aggregated sum to the registered entities.

16. The method of claim 15, wherein a single participating entity is comprised of two or more internal entities, and further comprising:
aggregating weights from one or more machine learning models locally coupled to the two or more internal entities;
locally encrypting the aggregated weights with the public AHE key, wherein the aggregated weights represent a homogenous data type, and
the single participating entity receiving the decrypted aggregated sum and propagating the aggregated sum to the two or more internal entities.

17. The method of claim 15, wherein the topology is a ring topology, and further comprising assigning a rank to each participating entity in the topology, and incrementally encrypting and aggregating machine learning model weights in a first topological direction responsive the assigned rank in the topology.

18. The method of claim 15, further comprising representing the local machine learning model weights as an array of weights, dividing the encrypted array into a plurality of two or more chunks, wherein a quantity of chunks is an integer representing a quantity of the registered participants, locally encrypting each chunk with the AHE public key, and synchronously aggregating the chunks in parallel and responsive to the topology.

19. The method of claim 18, further comprising concluding the synchronous aggregation when each participating entity is in receipt of a single aggregated chunk, transmitting the single aggregated chunk to a decrypting entity, subjecting the transmitted chunk to decryption with the corresponding AHE private key, concatenating the decrypted chunks, and distributing the concatenated decrypted chunks to the registered participating entities.

20. The method of claim 15, wherein the topology is fully connected, and further comprising:
each participating entity broadcasting the encrypted local machine learning model weights across the topology;
wherein the selective aggregation further comprises each participating entity locally aggregating received broadcasted encrypted weights; and
subjecting each local aggregation to verification of entity participation.
